(19) United States
(12) Patent Application Publication
(10) Pub. No.: US 2008/0306763 A1
(43) Pub. Date: Dec. 11, 2008

(54) System and Method for Modifying Risk Factors by a Healthcare Individual at a Remote Location

(76) Inventor: Terry L. James, Fairview, TX (US)

Correspondence Address: BAKER BOTTS L.L.P., 2001 ROSS AVENUE, SUITE 600, DALLAS, TX, 75201-2980, US

(21) Appl. No.: 11/760,457

(22) Filed: Jun. 8, 2007

(51) Int. Cl. G06Q 50/00

(52) U.S. Cl. 705/2

(57) ABSTRACT

A method for modifying risk factors by a healthcare individual at a remote location includes interacting with a participant at a remote location to obtain health-related data, such that the interaction occurs during a live video session. The healthcare individual determining an intervention plan to the participant based on the health-related data. The healthcare individual communicating data associated with the intervention plan to the participant during the live video session.

### TECHNICAL FIELD OF THE INVENTION

This invention relates in general to health management, and more particularly to a system and method for assessing, modifying, and intervening risk factors associated with disease and morbidity by a healthcare individual at a remote location.

### BACKGROUND OF THE INVENTION

Our nation currently spends over $1.5 trillion on healthcare each year. The past twenty years has witnessed unrelenting cost increases in healthcare. Just since 2002, costs have increased by thirty percent. Faced with an aging population and no end in sight to our ever-increasing healthcare expenditures, a myriad of potential solutions have been offered to slow, to reverse, or otherwise to reduce this problematic trend.

The proffered healthcare solutions have been many, including managed care, preferred provider organizations (PPOs), health maintenance organizations (HMOs), contracted services, plan designs, co-pay schemes, deductible strategies and consumer driven healthcare. These solutions initially seem diverse in appearance and unrelated in their approaches. They do, however, share common platforms. They focus on who is going to pay the incurred expenses (e.g. the employer versus the employee), how much providers of services (e.g. doctors and hospitals) are going to be paid, and how much the financial risk taker (e.g. insurance companies) will make for financing the uncertainty of who will experience illness and how much that illness will eventually cost. Engrained into this paradigm are suppliers and business support systems that offer their wares and services in hopes of participating in this ever-growing healthcare industry.

Employers often offer to share healthcare expenses with employees as a benefit to the employees. In such an arrangement, either the employer or the employee ultimately pays for the healthcare expenses. Once the employer offers healthcare as a benefit to employees, the employer assumes the risk of paying at least some portion of future healthcare expenses for those employees. If the employee population is healthy and requires little or no medical services, the employer's cost will be minimal. If the employee population is not healthy, then the employer's cost could be unaffordable. The employer then may choose to shift some of the risk (and some of the cost) to an insurer, the employees, or both.

An employer generally may shift costs to employees through various schemes such as: plan design, deductibles, co-pays, coverage limits, medical savings plans, etc. All of these schemes are designed to define who is going to pay and how much: the employer or the employee.

Healthcare costs, however, have continued to rise in the face of these monetary strategies, and that is a problem—a serious problem. Someone has to pay for medical services and there always seems to be someone who wants or needs those services. It is interesting that the prevalent thinking of the day has approached the problem of rising healthcare cost with solutions that focus on financing the risk associated with healthcare cost. The solutions are all centered on money. Who pays? Who is at risk to pay? Who gets paid what if this happens?

It seems strange to approach the problem of healthcare, people getting sick or not sick, with strategies around money. To date no one has found a disease caused by money or cured by money. People do not get infected with money, and money does not cause cancer. Health, or the lack of it, is about people. People get sick. People are healthy or unhealthy. Surprisingly little attention has been given to the individual's role in the rising cost of healthcare. The ‘money people’ are looking for ‘money solutions.’ After all, business is business. But without the need or the desire of individuals to seek medical services, the costs go down because demand for services goes down.

In fact, without people who become patients, healthcare ceases to exist. Unless someone is sick, hurt, or in pain, no health service is tendered. Without a patient, doctors and hospitals cease to exist. The impetus that drives the system for the healthcare players (i.e., physicians, hospitals, pharmaceutical manufacturers, suppliers, and insurers) is the irrefutable truth that there is a patient, one who is in need of care. Remove the patient from the equation and, rather suddenly, the healthcare players dissolve. Nothing disturbs a physician more than an empty waiting room, or a hospital administrator more than a barren surgery schedule.

It seems universally accepted by the healthcare players, and the thinking of the status quo, that the patient is merely someone who stands in need of care, who knew nothing of his illness, and who lacks any responsibility for his condition. The common thinking of the day continues that this unfortunate patient, due to circumstances beyond his control, just became ill. The healthcare players' interest is to make a product and to provide care for whoever needs it, but never eliminate the need for services, never reduce the demand. Ask a hospital administrator about wellness and the reply will likely be, “Why would I want a wellness program? I make a profit from sick people, not well people.”

The question arises: do patients just get sick or are they a causal agent in the risk for disease development? Could the patient, the passive participant in this disease by chance occurrence hypothesis actually be a fundamental driver of healthcare costs? If they are passive, are not playing an active role in the demand for medical services, and are only by-products of random misfortune, then any strategy that considers them is futile. If, on the other hand, the patient is a causal agent, then the chance to influence him must be fundamental in a risk management solution designed to affect healthcare expenditures.

It is our belief that the individual is a fundamental causal agent in the risk for disease development and a driving force for subsequent healthcare cost. Individual choices are critical to determining the likelihood of the occurrence of disease and the severity of the disease process. Furthermore, once a specific disease condition is present, how an individual relates to that condition serves as a primary driver in the severity of the disease process and its resulting cost of care.

Creating strategies that focus on the individual, in our opinion, can significantly alter the risk for disease development and further reduce healthcare cost. It is the individual, who has been neglected as a cost center in healthcare expenditures. Indeed, certain efficiencies may exist, that can be found, if individual choices are addressed. Such choices are vitally important because they put the patient at risk for disease development and generate corresponding healthcare expenditures, driving cost upwards, each and every year.

Individuals need proper tools, training and guidance in order to assess, modify, and intervene risk factors that drive disease and morbidity within their lives. In the course of their practice, physicians are often too busy to effectively provide the proper training and guidance for risk modification to individuals. Typically, physicians will instruct users to read some health education literature that may suggest one or more generic intervention methods for preventing or reducing health risks for a given individual. However, these intervention methods are not presented to the individual in an interactive and personalized environment from the physician. Additionally, physicians do not have the time or resources to effectively design, track, and monitor a risk modification plan for an individual. Furthermore, physicians cannot properly determine the compliancy rate of their patient population with a risk modification plan or reward their compliance.

### SUMMARY OF THE INVENTION

From the foregoing, it may be appreciated that a need has arisen for an improved process for achieving superior modification of risk factors that drive disease.

Generally, the presence of disease occurs due to antecedent risk factors. Disease is causal. Something is present to precipitate disease. These causal agents are called risk factors. For example, certain risk factors drive heart disease. If someone is a smoker, sedentary, obese and has high blood lipids, then these risk factors drive the formation of plaque in the arteries of the heart. In fact, physicians use the Framingham Score as a means for predicting the likelihood of a heart attack over the next ten years using many of these risk factors.

On the other hand, if risk factors are modified in some way, then the risk for disease is reduced. So the individual who stops smoking, loses weight, starts walking and lowers his blood lipids will reduce his probability for heart disease. Risk factors drive the disease process. If the risk factors are modified by eliminating, minimizing, attenuating, or reducing the risk factors, then the disease expression can be stopped or the morbidity associated with existing disease can be attenuated. An intervention plan is a plan to modify risk factors by either preventing their formation, reducing or eliminating their presence, or attenuating risk factors that drive future morbidity in an existing disease states.

In accordance with the present invention, disadvantages and problems associated with previous techniques for modifying risk factors may be improved upon or eliminated.

In accordance with one embodiment of the present invention, a method for modifying risk factors by a healthcare individual at a remote location is presented. The method includes capturing health-related data from a participant, storing the health-related data associated with the participant in a memory, and transmitting the health-related data associated with the participant, wherein health-related data is updated in real time with new captured health-related data. The method further includes interacting with the participant at a remote location to obtain additional data, such that the interaction occurs during a real time, live video session. The method also includes determining an intervention plan for the participant based on the health-related data and the additional data. Additionally, the method includes communicating data related to the intervention plan with the participant during the live video session.

In accordance with another embodiment of the present invention, the method for modifying risk factors for disease by a healthcare individual at a remote location includes determining a surveillance plan for the participant based on the health-related data and additional data. A healthcare individual can follow up with the participant based on the surveillance plan. The method further includes identifying one or more relevant risk factors from health-related data collected from the participant and analyzing the risk factors to determine the intervention plan for the participant or group of participants. The method also includes providing a health station at a remote location, capturing biometric data from the participant at the health station, storing the biometric data, transmitting the biometric data, and analyzing the biometric data to determine the intervention plan for the participant.

Important technical advantages of certain embodiments of the present invention include providing health information to a participant from a qualified healthcare individual (e.g. medical doctor, nurse, dietician, licensed individual, or non-licensed individual) regarding acute illness, chronic illness, or risk modification programs. This is due, at least in part, to health station, which is capable of providing live interaction via a communication session between participant and healthcare individual. The present architecture allows participant to visit remote health station and receive a similar experience with a healthcare individual as if participant visited healthcare individual's office in person. Health station provides one on one interaction between participant and healthcare individual, such that participant will have a more personal experience and be more willing to participate in the intervention plans suggested by healthcare individual. Health station also allows for participants to interact with healthcare individuals immediately, such that participants do not have to leave their place of employment. The present architecture is very efficient and cost effective for healthcare individuals who can receive participant data and visit with participants from several different geographic areas.

Other important technical advantages of certain embodiments of the present invention include providing an intervention plan based on updated health data and monitoring compliance of participant's participation with intervention plan. Health station can store health data associated with participant. Additionally, health station can collect biometric data and store this data associated with participant. Health station is operable to transmit participant's health data to healthcare individual. As a result, healthcare individuals can provide immediate and appropriate intervention plans for each participant based on health data associated with participant. Healthcare individuals can also interact with participants to obtain any additional data needed. Furthermore, healthcare individuals can require participants to submit updated health data via health station periodically, such that healthcare individual can monitor the progress of participant.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a simplified block diagram that illustrates a system for providing an intervention plan through interaction with a health station connected to a network in accordance with a particular embodiment of the present invention;

FIG. 2 is a simplified flowchart that illustrates an example method for collecting data and providing an intervention plan through interaction with a health station connected to a network in accordance with an embodiment of the present invention;

FIG. 3 is an example listing of health risk appraisal data;

FIG. 4 is a simplified block diagram of a data processing system for delivering and administering certain features of the present invention;

FIG. 5 is a simplified flowchart that illustrates an example of an algorithm in a health station in accordance with an embodiment of the present invention;

FIG. 6 is a simplified flowchart that illustrates an example method for providing an intervention plan for an acute illness in accordance with an embodiment of the present invention;

FIG. 7 is a simplified flowchart that illustrates an example method for providing an intervention plan for weight management in accordance with an embodiment of the present invention; and

FIG. 8 is a simplified flowchart that illustrates an example method for providing an intervention plan for heart disease in accordance with an embodiment of the present invention.

### DETAILED DESCRIPTION OF THE INVENTION

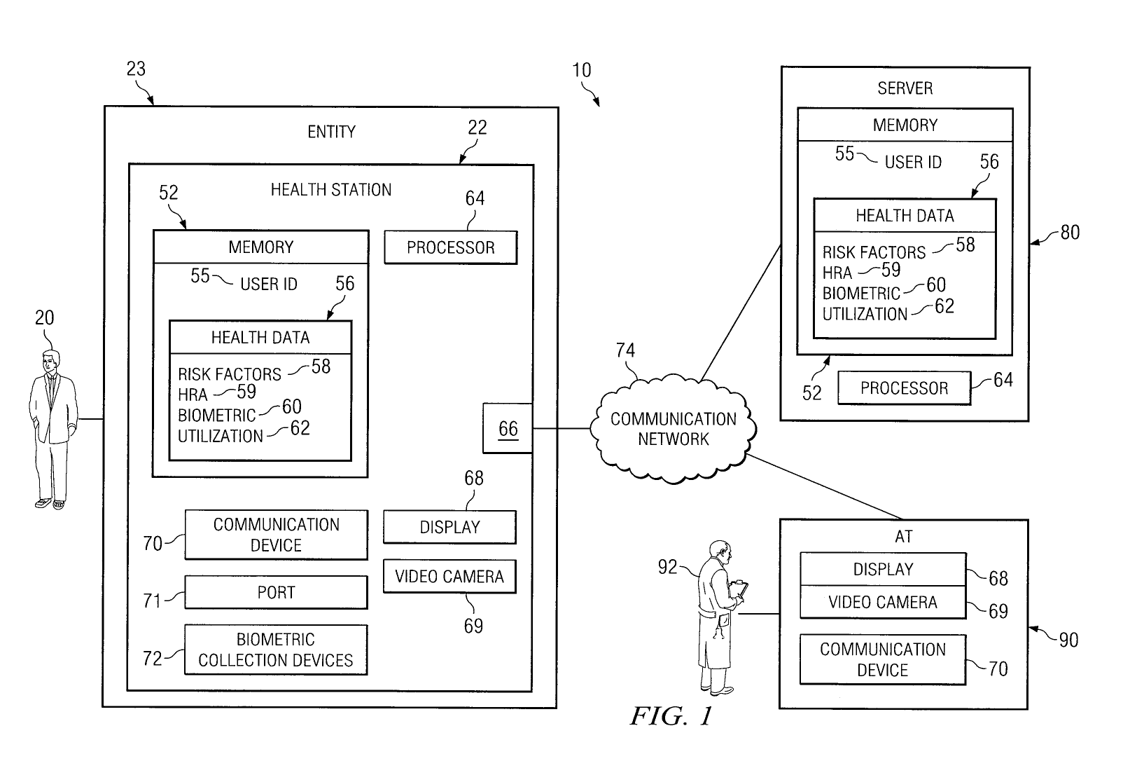

FIG. 1 is a simplified block diagram of a system 10 that that illustrates a system for providing an intervention plan through interaction with a health station on a network. According to the embodiment, system 10 includes a participant 20, health station 22, entity 23, communication network 74, server 80, access terminal 90, and healthcare individual 92. Health station includes memory 52, participant identification 55, health data 56, risk factors 58, health risk appraisal data 59, biometric data 60, utilization data 62, a processor 64, an interface 66, a display 68, a video camera 69, one or more communication devices 70, a port 71, and one or more biometric collection devices 72. Server 80 includes memory 52, participant identification 55, health data 56, risk factors 58, health risk appraisal data 59, biometric data 60, utilization data 62, and a processor 64. Access terminal 90 includes a display 68, a video camera 69, and one or more communication devices 70.

In accordance with the teachings of the present invention, communication system 10 achieves an effective way for participants 20 to receive healthcare management at a remote health station 22. Participants 20 can visit health stations 22 to receive health management from healthcare individuals 92, such that the participants 20 can immediately receive care related to an acute illness, chronic illness, or modification of risk factors for disease through an intervention plan. Participants 20 can interact with healthcare individuals via health station 22, which is connected to communication network 74. For example, participants 20 and healthcare individuals 92 can interact via a live video feed between health station 22 and access terminal 90. Health station 22 can store a multitude of health data 56 associated with participant. Additionally, health station 22 is operable to measure and store biometric data 60 of participant 20. Healthcare individuals 92 can receive this health data 56 associated with each participant 20 immediately. Healthcare individuals 92 can also obtain additional health data 56 by interacting with participant 20 via live video on health station 22. Healthcare individuals 92 can provide appropriate intervention plans to participants 20 based on the health data 56 and any additional data obtained from participants 20. Intervention plans can be related to any concern by participant 20, including acute illness, chronic illness, and risk modification for disease.

Software and/or hardware may reside in health station 22 and/or access terminal 90 and/or server 80 in order to achieve the teachings of the features of the present invention.

Note that, due to their flexibility, these components may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structure of health station 22 and/or access terminal 90 and/or server 80 in the context of system 10 and, accordingly, they should be construed as such.

It should be noted that the internal structure of the system of FIG. 1 is versatile and can be readily changed, modified, rearranged, or reconfigured in order to achieve its intended operations or additional operations. Additionally, any of the items within FIGS. 1-8 may be combined, where appropriate, or replaced with other functional elements that are operable to achieve any of the operations described herein.

System 10 offers advantages to participants seeking healthcare management from a qualified healthcare individual regarding acute illness, chronic illness, or risk modification for disease. This is due, at least in part, to health station, which is capable of providing real time, live interaction via a communication session between participant and healthcare individual. System allows participant to visit remote health station and receive a similar experience with a healthcare individual as if participant visited healthcare individual's office in person. System provides one on one interaction between participant and healthcare individual, such that participant will have a more personal experience and be more willing to participate in the intervention plan suggested by healthcare individual. System also allows for participants to interact with healthcare individuals immediately, such that participants do not have to travel to a doctor's office. System is very efficient and cost effective for healthcare individuals who can receive participant data and visit with participants from several different geographic areas.

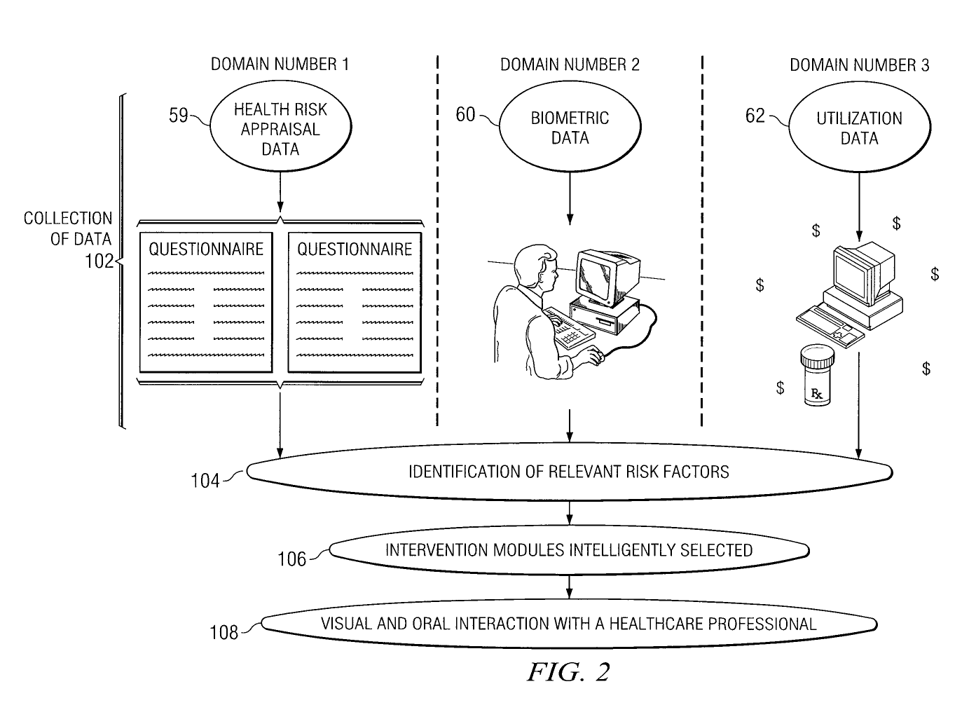

System offers additional advantages to participants seeking healthcare management from a qualified healthcare individual regarding acute illness, chronic illness, or risk modification for disease. Health station can store health data associated with participant. Additionally, health station can collect biometric data and store this data associated with participant. Health station is operable to transmit participant's health data to healthcare individual. As a result, healthcare individuals can provide immediate and appropriate intervention plans or acute care for each participant based on health data associated with participant. Healthcare individuals can also interact with participants to obtain any additional data needed. Furthermore, healthcare individuals can require participants to submit updated health data via health station periodically, such that healthcare individual can monitor the progress of participant. Details relating to these operations are explained below in FIG. 1 and FIG. 2.

Note that because the terminology associated with some of the elements of system 10 is malleable, it is helpful to offer some initial descriptions that address their meanings. As used herein, an intervention plan may be defined as an introduction of a variable (behavioral, chemical, process, etc.) that is designed to affect a risk factor that is present or could develop in a target participant or population. Therefore, an intervention may include a change, addition, or modification to any relevant risk factor associated with participant. In the context of an intervention, a number of modules may be introduced to affect behaviors of the targeted individual or group. The term ‘module’ is a task to be completed by the targeted participant. A module is defined in more detail below.

Within the structure of a given intervention plan, examples of a module from health station or healthcare individual may include having the participant change a prescription from medicine A to medicine B or a change in treatment from Dr. A to Dr. B (or a treatment protocol being changed while remaining under the care of the same physician). An example of an activity shift could include a recommendation to increase a level of physical fitness, to refrain from certain activities that pose an increased health risk, or to take precautions based on a particular set of symptoms or conditions identified for that particular participant. Other behavioral changes may stem from data that suggest certain categorical groups (e.g. age, gender, race, etc.) or populations may be more susceptible to designated afflictions (e.g., a healthcare individual could recommend annual mammograms for women over the age of 35). In still other scenarios, the intervention could involve a process to be implemented, whereby participant may be asked to interact with a nurse every twelve hours, immediately report cold symptoms to a primary physician, or log daily testing information in an electronic journal. All of these modifications may be part of one or more designated modules for the target participant or population of participants. Such modules are discussed more fully below.

Once health data associated with participant has been obtained, a specific intervention plan may be introduced that is designed to modify the participant's risk factor and achieve productive results. For example, if high blood pressure or high blood sugar is discovered to be a risk factor in a participant, an intervention would be applied (e.g. weight management) for that participant to reduce the negative health effects associated with obesity.

The proposed interventions or modules are generally of two kinds: behavioral based and non-behavioral based. Consider the case where there are healthcare costs and productivity costs associated with recurrent absences for employees of Company Alpha due to the flu. A non-behavioral based intervention and the modules associated with the intervention could direct the employees to take a flu shot and report the flu vaccination at the health station. Early intervention is critical to reducing an employee's length of absence caused by illness and severity of disease. An example of a behavioral based intervention and the modules associated with the intervention is to have participants practice stress management skills using a stress monitor that measures heart rate variability beat to beat at the health station. Combining one intervention to change behavior with another intervention to change a point of service or a level of c are optimizes the chances of achieving desired positive health effects on participant.

As used herein, the term “module” includes any task to be completed by the targeted participant in the context of an intervention plan. The modules can be selected intelligently from health station or server based on participant's health data, such that modules are displayed to participant via health station. Alternatively, modules can be created by healthcare individuals based on participant's health data, such that healthcare individual explains module via live video feed to participant at health station. In the context of an intervention plan, the modules are designed after analyzing the health data and identifying relevant risk factors associated with the target population. Hence, the identified relevant risk factors can be used as the basis for configuring the modules, which can be interactive and which specifically address the (potentially modifiable) targeted clinical risk factors, character observations, or disease states of the target population. Considerable time and effort may be expended in designing the precise modules that will yield the most beneficial results for the target group and, thereby, alleviate the healthcare costs for a given population of participants. Alternatively, a healthcare individual can immediately develop a module customized to participant based on participant's health data transmitted from health station. Thus, the modules in the context of an intervention plan are designed to modify risk factors and related healthcare expenses for a given participant or group, as determined by the identification of relevant risk factors and health data associated with participant. The modules associated with an intervention plan may also achieve a reduction in healthcare expenses by modifying the choices of the participant so that the participant chooses new behaviors or abandons old behaviors that are costly (e.g. calling the nurse line instead of going to the emergency room as a first choice in seeking health management).

Therefore, a module associated with an intervention plan could include virtually any action, exercise, or assignment that may affect a participant's beliefs, feelings, thoughts, or behaviors. This is inclusive of a participant refraining from doing some action or intentionally not participating in certain endeavors. There could be a series of successive modules to be completed by a participant in a particular order, or the modules could be completed in a random fashion. A module associated with an intervention plan is tailored specifically for a participant or a group of participants and, therefore, modules are considerably flexible and malleable. A module associated with an intervention plan may be completed during normal business hours (potentially under the supervision of an administrator), during non-business hours where the ‘honor system’ is employed, or anytime. Furthermore, an incentive program can be implemented, such that more participants will comply with intervention plans.

Note that the modules associated with the intervention plans are primarily action or process-oriented, as opposed to information-oriented, so that their focus is on the facilitation of change in participant. The modules are designed to allow participant to acquire skills and life applications of the learned information. Participant may be asked to respond affirmatively in order to address certain subject matter. In addition, participant may be required to perform specific tasks. Rewards may then be given based on the performance of the modules by participant, as he completes, applies, acquires, or participates in proscribed assignments within the modules.

A module associated with an intervention plan could include educational tools, such as a booklet, video, or computer program designed to address the illness, behavior, or issue presented by the target participant or group. For example, if the issue were stress management, a video could include information about proper diet (e.g. inclusive of caffeine restrictions), breathing exercises, time management, and sleeping suggestions. The booklet could include electronic fill-in the blank questions that quiz participant on the lessons learned.

The module associated with an intervention plan could also solicit personal reflections from participant. Note that such introspection is a powerful tool for addressing participant's psyche at a fundamental level. Completion of question and answer sections could be part of the module, but probing deeper by asking difficult and private questions may prove far more beneficial. This is critical. Knowledge, by itself, does not necessarily change behavior. Participant needs to make a conscious decision to accept the knowledge and then incorporate these teachings into their own life. Asking thoughtful questions that query a person as to how they are feeling, thinking, and processing the presented information helps to foster their development. A healthcare individual, such as a psychologist, asking questions to participant over a live video feed can accomplish this effectively since this will provide a more personal one on one experience.

Consider the following two questions that are illustrative of this concept. These questions could be provided in any potential module or asked by any healthcare individual. Question 1: How do you feel about your current health self-assessment? What surprises you and what concerns you? Please explain. Question 2: Based on all of the information that you have learned so far in this module, what is your number one reason for wanting to take responsibility for your health? Such questions are far removed from simple fill-in-the blank questions or insignificant true/false questions.

A wise philosopher once noted: to know, and to not do, is to not know. Such an aphorism is relevant in the realm of healthcare. Slipping a pamphlet under the door of every participant who has diabetes may not yield a change in behavior in these individuals. Facilitating change in participant is paramount. For example, in the case of a diabetic participant, the critical issue is to not only get participant to understand the value of blood sugar levels to their own wellness, but to make decisions that ensure that those blood sugar levels remain in an optimal range. A healthcare individual speaking to a diabetic participant over a live video feed can accomplish this effectively since this will provide a more personal one on one experience, create accountability, and raise expectations of performance for the participant. Note that this recognition and application by participant exhibits the knowledge and application components of the process being merged. After suffering an unfortunate incident or trauma (e.g. a seizure or a neuropathy), many diabetics might recount that they were made aware of a certain risk or a potential danger. For example, a diabetic individual who was a participant in a wellness program and received patient education may explain, “Yes, I recall once being told on the phone from a health coach about the dangers of failing to maintain my blood sugar levels. Such a response elucidates the futility of many wellness programs. However, an authorized healthcare individual, who provides a custom intervention plan for participant's specific concerns in a one on one setting over a live video feed, will have a much greater impact upon participant's compliance with the intervention plan.

Healthcare expenditures and risk factor accumulation have little to do with what people know or do not know. Instead, healthcare expenditures and risk factor accumulation have far more to do with how people think, feel, believe, and behave, and, further, the choices that they ultimately make to live their lives. Thus, many of the modules associated with an intervention plan presented herein are designed to facilitate the process of change so that participant makes new choices in life that reduce the risk factors that drive disease and morbidity. Changing the thought processes, belief, and choices of the target participant is key. Providing a remote health station with a real time, live video feed to an authorized healthcare individual helps accomplish these goals. Participants will feel more accountable, view intervention plan with more credibility, and will comply to a greater extent to an intervention plan as a result of having visual contact with a qualified healthcare individual as opposed to a textbook or videotape or phone call.

Modules associated with an intervention plan can also be related to physical exercises to be completed by participants. An honor system may be employed for such a module or participant may wear some type of activity monitor (e.g. a pedometer for tracking walking, a heart rate monitor for tracking other activities, etc.). In addition, a module associated with an intervention plan may include work completed using access terminal, health station, and, potentially, monitored by an on-line administrator. A module associated with an intervention plan could also simply be the completion or achievement of a specific goal. In the case of a person with heart disease, a reduction of participant's weight by fifteen pounds may signify performance or completion of the module. Participant can utilize weight scale on health station to record weight and transmit weight electronically to healthcare individual, such that healthcare individual can check if participant is complying with module. Other modules associated with an intervention plan could include the verification of medication usage in the presence of a healthcare individual. For example, a diabetic may be reluctant to take his proper insulin dosages and, therefore, present a significant financial healthcare risk for a company. A module associated with an intervention plan could be designed specifically to address this problem, whereby a full month of consistent dosages (reflected by a nurse's log or by periodic measurement of blood sugar levels for this individual) reflects the completion of a module. The subsequent module associated with the intervention plan for participant could include a three-month period of consistent medication, which can be reflected by three months of consistent blood sugar levels being recorded at health station.

Other modules associated with an intervention plan may be completed in a group setting. For example, if unplanned pregnancies are an issue causing absences and rising healthcare costs for a company, a module associated with an intervention plan could include female participation in a group meeting that includes women who previously experienced an unplanned pregnancy. Note that the group dynamic provides an opportunity for individuals to encourage each other in participating in the module. Thus, certain modules associated with an intervention plan may solicit participation by an entire group of individuals for successful completion of the module. Group meetings could be held by having multiple health stations with multiple participants communicate with each other over the Internet with a healthcare individual conducting the group meeting. This group dynamic concept is a distinct issue that holds value.

Other modules associated with an intervention plan could implement the use of external sources. For example, one module associated with an unplanned pregnancy intervention could include regular attendance at Planned Parenthood meetings for three months, where information is regularly exchanged about contraception, proper nutrition, and exercise. The attendance at this meeting could be discussed with the healthcare individual on a subsequent health station visit. Similarly, regular attendance at Alcoholics Anonymous could be required and reported to the healthcare individual at a scheduled meeting at the health station. Other variations and permutations in the design of the modules associated with an intervention plan may be ascertained by simply focusing on the correctable and modifiable behaviors of the underlying target individual or group: behaviors which affect risk factor modification for disease or morbidity.

According to the illustrated embodiment, system 10 provides services such as communication sessions to endpoints, such as access terminal 90 and health station 22. A communication session refers to an active communication between endpoints. Information may be communicated during a communication session. Information may include voice, data, text, audio, video, multimedia, control, signaling, and/or other information. Information may be communicated in packets, each comprising a bundle of data organized in a specific way for transmission.

System 10 may utilize communication protocols and technologies to provide communication sessions. Examples of communication protocols and technologies include those set by the Institute of Electrical and Electronics Engineers, Inc. (IEEE) standards, the International Telecommunications Union (ITU-T) standards, the European Telecommunications Standards Institute (ETSI) standards, the Internet Engineering Task Force (IETF) standards (for example, IP such as mobile IP), or other standards.

According to the illustrated embodiment, participant 20 represents any individual who visits health station 22. For example, participant 20 may suffer from an ailment, such as acute illness, chronic illness, or risk factor for disease such as stress, etcetera. Participant 20 can visit health station 22 and immediately receive appropriate care from a healthcare individual 92. Participant 20 may also participate in risk modification via health station 22. Risk modification and intervention plans can include plans designed to affect participant's health conditions, such as diabetes, weight management, heart disease, etcetera. Additionally, participant 20 can visit health station 22 to measure biometric data 60. Participant 20 can also dock activity monitor with health station 22, such that participant can upload and view activity data. In another embodiment, participant 20 may be an employee who is required by employee's employer to visit health stations 22. In another embodiment, participant 20 may be an individual in a nursing home who is required to visit health station 22 on a periodic basis. In another embodiment, participant 20 may be a student who is required to dock activity monitor as part of a physical education curriculum.

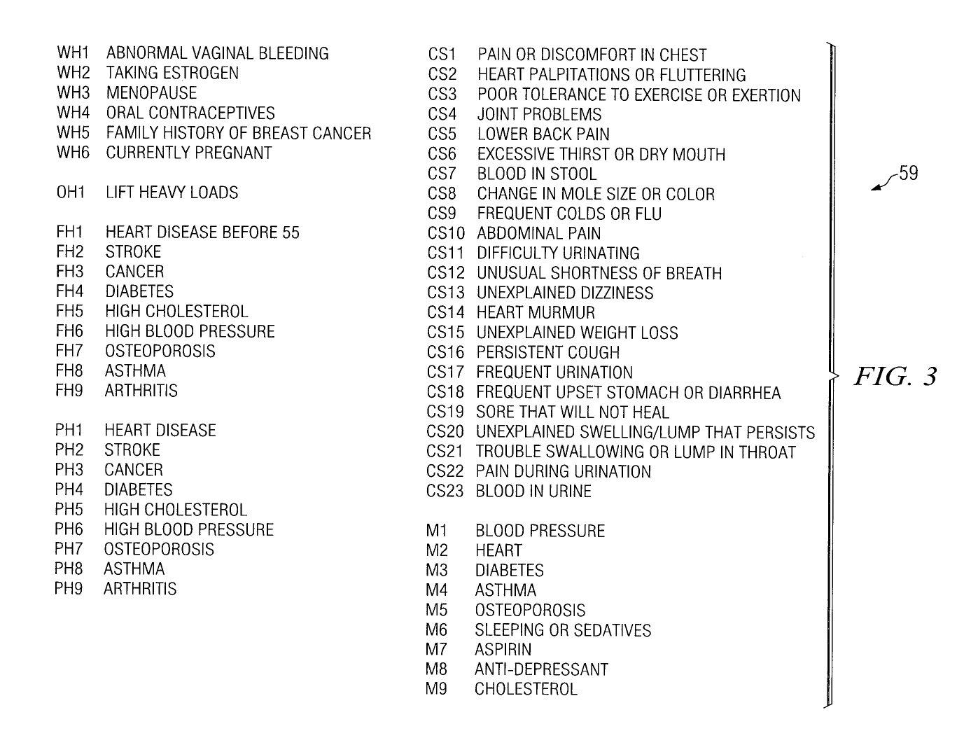

According to illustrated embodiment, health station 22 represents any suitable device operable to collect biometric data 60 from participant 20, provide visual and audio communication session between participant 20 and healthcare individual 92, and exchange information between participant 20 and healthcare individual 92 in essentially real-time. Health station 22 may represent a computer, server or data processing system, depending on context and applicable tasks. In the current embodiment, health station 22 is located within an entity 23. Health station 22 can include a memory 52 storing a participant's identification data 55 and health data 56 (for example, risk factors 58, health risk appraisal data 59, biometric data 60, and utilization data 62), processor 64, network interface 66, display 68, video camera 69, one or more communication devices 70, port 71, and one or more biometric collection devices 72. Health station 22 can be constructed from any material with any suitable design. For example, health station 22 may be constructed from wood in the shape of a bench seat, including a monitor, a telephone, a video camera, and a weight scale, such that the weight scale is positioned under the seat so that participant can measure weight while sitting. In another embodiment, health station 22 may be constructed from metal in the shape of a rectangular box, including a monitor, built in speaker, and built in microphone. Participants 20 can interact with health station 22 to receive an intervention plan from a healthcare individual 92 via a video session. Health station can schedule an appointment for individual to connect to healthcare individual via a live video session. Alternatively, health station can show a pre-recorded video session to communicate between participant and healthcare individual. Details relating to providing an intervention plan based on obtained data are explained below in FIG. 2 and FIG. 5. Health station 22 can capture a multitude of data. For example, health station 22 can capture participant's name, risk factors, health risk appraisal data, biometric data, utilization data, medical records, health insurance enrollment data and any other relevant data. Details relating to this data are explained below in FIG. 2 and FIG. 3. Health station 22 can save data associated with each participant on a remote server 80, such that health station 22 will have participant's information on subsequent visits. Health station 22, including biometric collection devices and electronic intervention modules, can be customized and configurable by authorized individuals, such as healthcare individuals 92. For example, entity ABC can configure their health station 22 so that activity monitors can connect to health station. More details relating to data capture are explained below in FIG. 2 and FIG. 5. Other architectures and components of health station 22 may be used without departing from the scope of this disclosure.

In an alternative embodiment, participant can communicate with a healthcare individual to receive acute care or participate in an intervention plan by using a computing device with a display, such as a desktop computer, laptop, pda, cell phone, etc. For example, healthcare coverage from employer may also cover spouses of employees. A spouse of employee can use their computer at home to communicate with a healthcare individual over a real time, live video connection.

Entity 23 can be any location where health station 22 or computing device is located. Entity 23 can include a company, a university, a residence, an elementary school, a nursing home, a grocery store, a gym, etcetera. For example, a company can use health station 22 to lower costs and increase productivity from employees. Employees at company can visit health station 22 rather than a doctor's office when employee is feeling sick, which can provide employee with an immediate health management and minimize the time employee is away from work. Employees at company can also visit health station 22 to participate in risk modification interventions for general health risk, such as weight management and risk factors specific for heart disease, such as lowering a participant's LDL. Companies can lower costs associated with healthcare and absenteeism as a result of employees participating in risk modification intervention plans via health stations located within the company. In another embodiment, health station 22 can be located in a grocery store, such that participants 20 can participate in an intervention plan from a convenient location.

Memory 52 may be located in health station 22, server 80, and/or access terminal 90. Memory 52 accessed or otherwise utilized by one or more components of health station 22, server 80, or access terminal 90. Memory 52 may take the form of volatile or non-volatile memory including, without limitation, magnetic media, optical media, random access memory (RAM), read-only memory (ROM), removable media, or any other suitable local or remote memory component. In general, memory 52 may store various data including participant's identification data, health data, and modules.

Participant identification 55 can be stored on health station 22 and/or server 80. Participant identification 55 is used by health station 22 and server 80 to store and update health data 56 associated with participant 20. Participant identification 55 can be obtained from a card reader, fingerprint scanner, or any other well-known software or hardware authentication system. In one particular embodiment, health station 22 and server 80 can recognize participant's identification 55 from participant's activity monitor connected to health station 22. Alternatively, health station 22 can prompt participant 20 for participant identification and password. Each participant 20 can receive a personalized experience with customized settings stored in memory associated with participant's identification 55.

Health data 56 can be any data associated with participant 20. Health data 56 is analyzed by healthcare individuals 92 to provide an appropriate intervention plan customized to each participant 20. Health data 56 can include risk factors 58, health risk appraisal data 59, biometric data 60, utilization data 62, intervention plans, and any other data related to participant's health.

Risk factor 58 is a clinical observation that has been statistically demonstrated to participate in the development of a given disease. Healthcare individuals 92 can determine risk factor 58 of participant 20 by analyzing health data 56 or asking participant 20 questions during live video session. For example, if participant 20 is sedentary, obese, or is a smoker, participant 20 has clinical risk factors 58 for heart disease. However, there are other clinical observations that would not qualify as a “clinical risk factor.” For example, the fact that participant 20 was a certain height or had poor vision would not necessarily qualify as a clinical risk factor 58 for heart disease.

Clinical risk factors 58 tell you if participant 20 is at risk for developing a disease or condition, but clinical risk factors 58 do not tell you when that disease process is likely to occur, the appropriate intervention plan to modify risk factors, or its potential cost for the party bearing the economic risk.

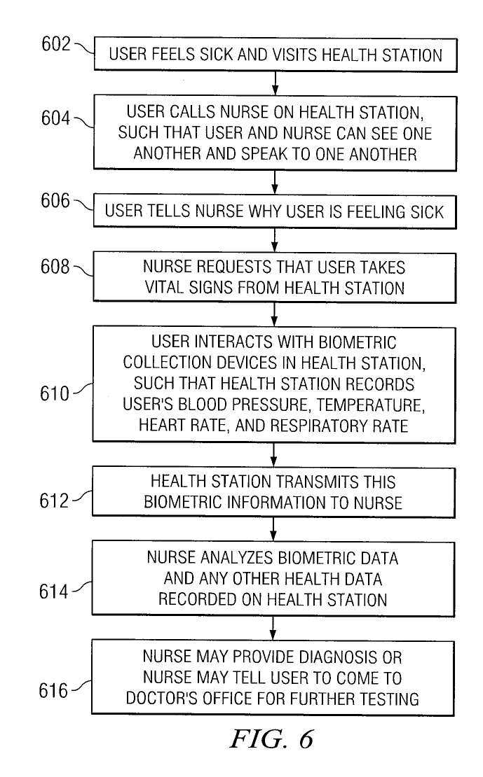

By merging clinical risk factors 58 with other data domains, healthcare individuals 92 can determine a proper health management to provide both acute care and acute surveillance for a given participant. For example, a healthcare individual 92 can determine that participant 20 who has risk factors 58 related to smoking may receive different health management than participant 20 who has no risk factors 58 for smoking. Healthcare individual 92 can provide acute surveillance by requesting that a smoker with a respiratory infection call back every twelve hours so that healthcare individual 92 can track participant's illness. Alternatively, healthcare individual 92 may not need to provide acute surveillance for a non-smoker with a respiratory infection since this participant 20 does not pose as high a risk. Details related to specific intervention plans are explained below in FIGS. 6-8.

As used herein, health risk appraisal data 59 represents information that is extracted indirectly or directly from participant 20 or healthcare individual 92. This information may be self-reported, for example, through a questionnaire or an interview that is completed by participant 20. Examples of such information include data relating to family history, current symptoms, previous surgeries, nutrition, smoking and alcohol habits, occupation, gene sequence, medication (past or present), or allergies. Note that because such information may reflect a specific trait of a participant 20 or a population of participants 20, their specific constraints or conditions may be accounted for and accommodated.

For example, the fact that participant 20 is an investment banker in Manhattan, N.Y. may reflect a high stress level. Health risk appraisal data 59 could reveal such information, whereby the interview and/or the questionnaire could directly solicit this important fact. Thus, the interview and/or the questionnaire may be customized to address a particular population or particular participant. Consider another example where participant population is predominantly women. Appropriate questions for the interview and/or the questionnaire may then be associated with family history and breast cancer (note that gene sequence identification may be part of such an inquisition, as certain identified gene sequences do reveal a greater likelihood of breast cancer) or capabilities related to procreation potential. Numerous other examples of health risk appraisal data 59 are provided herein in this document for purposes of example and illustration. Alternatively, health risk appraisal data 59 could include any other suitable self-reported information, condition, symptom, or any other relevant fact, parameter, or piece of data that is relevant to the health of the individual or the group being evaluated.

As used herein, biometric data 60 reflects measured health information that is not necessarily self-reported. This information may be gathered from (or relate to) participant 20 and generally reflects physical data, which is measured. In this particular embodiment, health station 22 is operable to measure participant's biometric data 60, including blood pressure, pulse, glucose levels, weight, air flow, etcetera. Health station 22 can collect detailed measurements of biometric data 60. For example, health station 22 can collect detailed measurements related to heart pressure, such as systolic pressure, diastolic pressure, and heart rate. Biometric data 60 may relate to diagnostic information that could be provided in a laboratory report or gathered, for example, during the course of a magnetic resonance imaging (MRI) scan, in the context of evaluating a employee, or in performing some type of lab work or blood-work. In other scenarios, biometric data 60 may involve assessing body fat and blood cholesterol, lung capacity (e.g. using a flow meter), height, density and weight measurements, or any other suitable test or evaluation that yields some tangible result for an examining healthcare individual. In still other embodiments, this could include testing (e.g. psychiatric evaluations) that involves questionnaires, inkblot tests, etc. Alternatively, biometric data 60 could include any other suitable physical measurement, dimension, relevant health fact, parameter, or piece of data that may be collected by a physician, nurse, or representative authorized to do so.

As used herein, utilization data 62 refers to economic data that reflects financial information tied to the person or group being evaluated. This could include how much money is spent on pharmaceutical supplies, or some particular event such as a doctor visit or a trip to an emergency room at a local hospital. Utilization data 62 may be solicited from a third party carrier or a third party administrator or, alternatively, through any other suitable entity. This may be inclusive of records searching in an appropriate database or file system. Utilization data 62 may reflect an economic event in which medical service triggered any type of fee. Such data is tied into costs incurred by a participant or by an employer on behalf of the participant. Alternatively, utilization data 62 could include any other suitable information or piece of data that may affect expenses or healthcare costs for participant or group of participants that is being evaluated.

Processor 64 can be located in health station 22, server 80, and access terminal 90. Processor 64 controls each device by processing information and signals. Processor 64 includes any suitable hardware, software, or both that operate to control and process signals. Processor may be microprocessors, controllers, or any other suitable computing devices, resources, or combination of hardware, software and/or encoded logic. In one particular embodiment, processor is operable to intelligently select intervention modules based on participant's health data. In a particular embodiment, processor 64 in health station 22 is operable to receive software, module, and website updates from centralized server 80. For example, health station 22 can receive new software from server 80 for measuring biometric data from a new biometric collection device, such that an individual does not have to make software changes to each health station 22 at a remote location.

Interface 66 receives input, sends output, processes the input and/or output, and/or performs other suitable operation in accordance with this invention. Interface 66 may comprise hardware and/or software.

Display 68 on health station 22 and access terminal 90 is operable to display one or more images in one or more formats. Images viewed on display 68 may include websites, streaming video, digital photographs, or any other suitable image. For example, participant 20 can view website associated with participant's health data and an embedded window within website that streams live video of healthcare individual 92. In another embodiment, display 68 can be a touch screen, such that participant 20 will have a more interactive experience. Since display 68 is touch screen, participant 20 can interact with health station 22 without a mouse or keyboard.

Video camera 69 on health station 22 and access terminal 90 is operable to stream live video of participant 20 or healthcare individual 92 across network 74. Additionally, video camera 69 is operable to take digital photographs and transmit digital photograph across network 74. For example, on initial visit to health station 22, participant 20 may take photograph from video camera 60 for participant's personalized webpage. Participant 20 can then connect to a live video feed with healthcare individual 92, such that participant 20 and healthcare individual 92 can see and speak with one another in essentially real time to provide a personal one on one experience.

Communication devices 70 on health station 22 and access terminal 90 are operable to facilitate communication. For example, communication devices 70 can include a microphone, speaker, keyboard, mouse, etcetera. Communication devices 90 may be internal to health station 22 or access terminal 90 or communication devices 90 may be an auxiliary device attached to health station 22 or access terminal 90.

Port 71 on health station 22 is operable for any electronic device to communicate with health station 22 and network 74. In one particular embodiment, participant 20 can log into health station by connecting activity monitor to port 71. Health station 22 can then automatically upload participant's website and participant's personal data. In another embodiment, participant 20 may upload digital photographs from a digital camera to memory in health station 22 or server 80, such that participant 20 connects digital camera to port 71.

Biometric collection devices 72 on health station 22 are operable to measure and store participant's biometric data 60 in memory 52. Biometric collection devices 72 can measure blood pressure, pulse, glucose levels, weight, air flow, etcetera. Biometric collection devices 72 are also operable to store data in memory 52 and transmit collected biometric data to health station 22, server 80, and/or access terminal 90. In one particular embodiment, participant 20 can place arm in cuff attached to health station 22, such that cuff measures participant's blood pressure. Blood pressure cuff can collect detailed measurements related to blood pressure, such as participant's systolic pressure, diastolic pressure, and heart rate. In another embodiment, participant 20 can sit down and place feet on bar positioned under the seat of health station 22, such that bar accurately measures participant's weight. In another embodiment, participant 20 may step on a traditional weight scale attached to health station 22, such that scale accurately measures participant's weight. Biometric collection devices 72 allow for healthcare individuals 92 to receive biometric data 60 and provide an immediate intervention plan to participant 20 located at remote health station 22.

System 10 includes a communication network 74. In general, communication network 74 may comprise at least a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication links, or any combination of any of the preceding.

Servers 80 are generally operable to provide an interface between participant health data 56 and healthcare individual. Servers 80 are also generally operable to store intervention plans, health data 56, and customized settings associated with participant 20 interacting with health station 22. One or more servers 80 may be web application servers or simple processors operable to allow healthcare individuals 92 to view and process participant health data 56 and intervention plans via the communication network 74 using a standard participant interface language such as, for example, the HyperText Markup Language (HTML). In some embodiments, one or more servers may be physically distributed such that each server 80, or multiple instances of each server, may be located in a different physical location geographically remote from each other. In other embodiments, one or more servers 80 may be combined and/or integral to each other. One or more servers 80 may be implemented using a general purpose personal computer (PC), a Macintosh, a workstation, a UNIX-based computer, a server computer, or any other suitable processing device.

Servers 80 are also operable to transmit updated software, modules, and websites to health stations 22, such that authorized individuals only have to make one update without visiting every health station 22. For example, authorized individual can create new software for recording biometric data 60 from a newly installed biometric collection device 72. Server 80 can transmit this new software to each health station 22, such that health station 22 will automatically receive the software update.

In another embodiment, server 80 is operable to intelligently select intervention modules customized to participant 20 based on participant's health data. The intelligently selected intervention modules can be transmitted to participant 20 or healthcare individual 92. Healthcare individual 92 can use the intelligently selected modules to help guide selection of a customized intervention plan for participant 20. For example, a nineteen year old overweight male with high blood pressure may receive modules on sexually transmitted diseases (health concern of young males) and weight management. A forty-five year old woman with normal weight and blood pressure may receive modules on cervical cancer and breast cancer.

In some embodiments, servers 80 are operable to provide security and/or authentication of participants 20 connected to health station 22 or healthcare individuals 92 attempting to access participant's health data 56.

In particular embodiments, one or more servers 80 are web application servers operable to communicate dynamically updated information to particular access terminal 90 and/or health station 22 via communication network 74. For example, one or more servers 80 may communicate dynamically updated information of biometric data to particular access terminals 90 via communication network 74.

According to the illustrated embodiment, access terminal 90 represents any suitable device operable to transmit a video stream and communicate with a communication network 74. Access terminal 90 can include a display 68, video camera 69, and one or more communication devices 70. For example, healthcare individual 92 may use access terminal 90 to receive a video stream and audio stream of participant 20 at remote health station 22. Access terminal 90 can also receive health data, modules, or images associated with participant 20 from health station 22 and/or server 80. Access terminal 90 may comprise, for example, a personal digital assistant, a computer such as a laptop, a cellular telephone, and/or any other device operable to communicate with system 10. Access terminal 90 may be a mobile or fixed device.

Healthcare individual 92 can be any qualified individual (licensed or non-licensed individual) capable of providing health management and risk management to participant. Health management may include acute care, evaluation, triage, treatment, and information. Risk management may include assessing risks, designing an intervention plan, determining risk modification, implementing the intervention plan, and evaluating effectiveness of the intervention plan. Risk modification can include preventing risks, reducing present risks, and attenuating risks associated with a health condition, such as heart disease and diabetes. Healthcare individuals 92 can include physicians, nurses, dieticians, exercise trainers, health coaches, or any individual authorized to make intervention plan decisions based on participant health data 56. Healthcare individual 92 can be contacted via a live video stream from participant 20 at remote health station 22. Healthcare individual 92 can apply acute care for acute illnesses. Healthcare individuals 92 can provide different intervention plans for different participants 20 based on participant's health data 56 and symptoms. By receiving intervention plans or care from a real person on a live video stream, participants will have a more personalized one on one experience. In addition, a qualified healthcare professional providing intervention plans will provide more credibility to intervention plans, which will increase participation in intervention plans. Furthermore, healthcare individuals 92 can apply intervention plans in a preventative way to a single participant 20 or a group of participants 20 at entity 23 based on health data 56 stored on server 80. For example, healthcare individual 92 may enroll all heart attack victims in a heart smart plan, which is designed to lower the risk factors associated with a future cardiac event. Participants 20 will be more likely to participate in intervention plans when they are required to explain progress to healthcare individual 92 face to face over a live video stream. Additional details of healthcare individuals 92 applying intervention plans based on participant's health data 56 transmitted from health station 22 and/or server 80 are listed below in FIGS. 2, 6, 7, and 8.

In another embodiment, healthcare individual 92 can work for an insurance carrier. Insurance carrier can use health stations 22 to maximize profitability. Insurance carriers can charge premiums to entities 23 or participants 20 for short term and long term disability. The amount the insurance carrier charges entities 23 or participants 20 for the premiums is based upon risk. Insurance carriers can use health stations 22 to receive immediate intelligence and health data 56 on participant population of entity 23 to limit the costs associated with participant's healthcare. For example, healthcare individual 92 can determine an appropriate intervention plan for participant 20 based on participant's health data 56. This intervention plan can prevent an illness from becoming a short term disability, and prevent a short term disability from becoming a long term disability. Additionally, if a high risk participant gets ill, then carriers can budget for a high risk patient that may go on long term disability. Therefore, health station 22 can provide health data 56 that has value at the insurer level and at the caretaker level.

In another embodiment, healthcare individual 92 can use health station 22 to sort and process participant health data 56 to provide intervention plans to population of participants at a particular entity 23. Participation in the group intervention plans will result in lower healthcare costs and fewer employee absences. Additional details of healthcare individuals 92 providing preventative intervention plans based on participant's health data 56 are listed below in FIGS. 2, 6, 7, and 8.

In another embodiment, healthcare individuals 92 and/or intelligence located in server 80 can determine a risk level for each participant 20. Participants 20 may be risk-stratified into appropriate categories (e.g. low risk, medium risk, and high risk). Note that such an environment is fluid; it is dynamic and constantly evolving. Such changing health factors, as well as the natural progression of a given disease, can readily be appreciated by healthcare individuals 92. Through diligence and a complete investigation, it may be revealed that six of the 5,000 participants at a particular entity had heart attacks and a corresponding bypass surgery. Further, by means of a cost stratification analysis, it may be discovered that these six individuals collectively cost the company almost $500,000 in healthcare and absenteeism costs. An in-depth evaluation may also uncover that, for these patients, these medical issues have generally been stabilized. While the basic disease process remains, the immediate conditions that caused the heart attack and their huge associated expenditures have been addressed through their surgeries. After consulting with their physicians, it may be confirmed that these patients are stable, their health conditions have been successfully addressed, and the need for ongoing invasive treatment is non-existent over the next twelve months. Moreover, the large prior costs associated with these patients are not likely to recur. Thus, even these six patients, who were a huge healthcare and absenteeism expenditure for the entity, would be placed in the low risk heart disease category. However, healthcare individuals 92 can still provide intervention plans for these low risk heart patients, such that healthcare individual can periodically monitor compliance for risk modification and health status of participants.

However, through the same in-depth analysis, it may be revealed that another patient in the heart disease group (“Herman”) had a severe heart attack, has a history of multiple hospitalizations, and, further, that he suffers from congestive heart failure. Herman's condition is not something that can be easily treated by a single event such as a bypass surgery. Herman has a demand for ongoing treatment. Not only is Herman most likely to see his overall health decline, there is a significant risk that Herman's future healthcare expenses and absenteeism will increase because of his condition. Accordingly, Herman would be designated in the high risk heart disease category for future expenses. Therefore, healthcare individuals 92 can provide Herman with a more rigorous intervention plan designed to modify those risk factors that could alter his health status and continual surveillance would be required to reduce Herman's absenteeism and health costs.

Within a specific disease state (e.g. heart disease, diabetes, lung cancer, etc.) there are relevant risk factors 58, which serve as the basis for ranking participants 20 into low, medium, or high risk categories. It is the underlying relevant risk factors 58 within the disease state that are critical for determining future absenteeism and health issues.

FIG. 2 illustrates an example method for collecting health data 56 from multiple domains and providing intervention plans based on this health data 56 in accordance with one embodiment of the present invention. At step 102, health station, entity and/or healthcare individuals collect data from participant. System may include three domains of information, which are used as a basis for identifying relevant economic risk factors and for providing customized intervention plans. The domains include: health risk appraisal data, biometric data, and utilization data. The information collected may be reviewed and processed in order to highlight relevant economic risk factors, which may later be used to develop a specific intervention over a designated time period. Thus, the information collected in this first step may be used as a basis for subsequent steps to be completed in order to manage health conditions and risks for the targeted participant. In the context of an example that includes the use of these three information domains (health risk appraisal data, biometric data, and utilization data), the following scenario is illustrative. Participant may complete an interview session in which participant answers truthfully that participant has asthma and a history of heart disease in participant's family (this represents health risk appraisal data). Participant may then be tested using a flow meter connected to a health station that indicates participant has limited lung capacity (this represents biometric data). Participant may also have blood pressure measured by a cuff connected to health station that indicates participant has high blood pressure (this represents biometric data). Finally, querying participant via live video at a remote health station may yield that participant purchases several inhalers per month, that participant was rushed to the hospital last year for an asthma attack, and that participant is currently taking prescription medication to lower participant's blood pressure (this represents utilization data).

At step 104, relevant risk factors are identified after the data is collected from the three domains. This represents the second step in the process and method for managing participant's health concerns. The purpose of the risk identification step is to discover relevant risk factors that reflect predictable events or conditions and, further, whose modification can lead to a reduction in health risks and disease expression. Modifying or eliminating a risk factor can prevent future health events and disease developments.

Let us explore what constitutes risk factors 58. Medical research has determined that the probability of developing a disease is associated with specific risk factors. For example, there are generally five primary lifestyle risk factors for heart disease: i) smoking, ii) sedentary lifestyle, iii) obesity, iv) high blood pressure, and v) elevated blood lipids. Logically, modifications to these risk factors reduce the risk for disease development, as well as death, disability, and illness resulting from a heart attack. Further, these risk factors may be used in order to develop a specific intervention that fits the needs of the targeted participant or population.

At step 106, healthcare individual and/or server can intelligently determine an intervention plan customized to participant based on participant's health risk appraisal data, biometric data, utilization data, risk factors, and any additional relevant health data. Healthcare individual can immediately view and process data associated with participant to provide an intervention plan almost immediately. This provides healthcare individual with specific data to provide an efficient and effective intervention plan to reduce the risk of disease associated with participant.

At step 108, healthcare individual can provide health management in real-time via a video stream to participant at a remote health station. The health management provides the participant with a clear and definitive plan of attack for managing participant's health concerns, such as acute illness, chronic illness, or risk modification. More specific intervention examples are detailed below in FIGS. 6-8. Health station allows one on one interaction between participant and healthcare individual, such that participant will have a more personal experience and be more willing to participate in intervention plans or care suggested by healthcare individual. Healthcare individuals can also interact with participants to obtain any additional data needed. For example, healthcare individual may request participant to measure blood pressure via biometric collection device attached to health station. Furthermore, healthcare individuals can require participants to submit updated health data via health station periodically, such that healthcare individual can monitor the progress of participant. For example, healthcare individual can require participant to measure blood pressure at health station once a week, and health station can transmit these results to healthcare individual for analysis. If intervention plan, which included medication, is not affecting blood pressure, then healthcare individual may request participant to have another one on one communication session via live video stream. Participant will be held accountable if participant is not following intervention plan. If participant is following program without positive results, healthcare individual can modify intervention plan until desired results are obtained. Once the intervention plans have been successfully completed, the overall value of the process may be displayed: comparing biometric data and other health data, such as utilization data, before the intervention plan to biometric data and other health data, such as utilization data, after the intervention plan by using a statistically validated method of evaluation. This translates into a tangible result to be compared and validated for any interested party (e.g. the entity or participant). Such a protocol avoids speculative claims or prognostications that may or may not prove truthful. This process produces a true bottom line result that can reflect changes in making comparisons year over year.

It is important to note that the stages and steps described above illustrate only some of the possible scenarios that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within health station 22 to effectuate the tasks and operations of the elements and activities associated with executing compatibility functions.

FIG. 3 is an example listing of health risk appraisal data 59. It is critical to note that such a listing has been offered for purposes of example and teaching only, and in no way should be considered exhaustive. Other health attributes can be readily accommodated by system 10 in accordance with particular needs or concerns. A series of codes are listed to the left of each of the data.

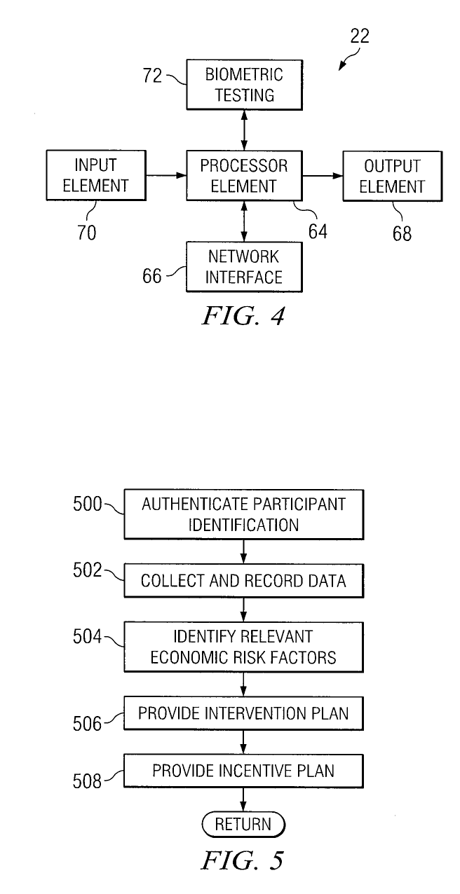

FIG. 4 is a simplified block diagram of a data processing system for delivering and administering certain aspects of the invention. In one embodiment, the data processing system, referred to herein as a health station 22, comprises a processor element 64, an input element 70, an output element 68, biometric testing element 72, and a network interface 66. Health station 22 may represent a computer, server, client, or data processing device, depending on context and applicable tasks. In certain embodiments, input element 70 and output element 68 may be combined into a single user interface element, such as a touch-screen display or kiosk. Moreover, health station 22 generally includes a means for authenticating participant (e.g., a participant in an intervention). The means for identifying a participant may include a card reader, fingerprint scanner, or any other well-known software or hardware authentication system.

Health station 22 provides a means for delivering an intervention to a given population, and thereby modifying risk factors that are driving disease and costs. Moreover, health station 22 may provide a means for administering an incentive program associated with the intervention. Health station 22 may authenticate a participant, track participation, store relevant data, report intervention progress or incentive program status. A data processing system such as health station 22 also may be configured with software, application specific integrated circuits (ASICs), or other means to implement an algorithm associated with intelligently selecting an intervention plan based on participant's health data.

In certain embodiments, network interface 66 may be coupled to a communications network (e.g., the Internet) or any other communicative platform operable to exchange data or information with other data processing systems. The provided communications network may alternatively be any local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment.

When the communications platform is network-based, the functions of health station 22 may be distributed across several health stations 22 or data processing systems. For example, participant history and biometric data 60 may be collected through a first health station 22, and then transmitted to a second health station 22, server 80, or other data processing system at a remote location for storage or further processing. Moreover, several health stations 22 may be located at various locations to service geographically distributed populations, and a network-based health station 22 provides a means for a participant to remotely input, change, or update health data 56, as well as participate in certain intervention activities.

To illustrate some of the advantages of health station 22, assume that relevant economic risk factors for coronary heart disease of a particular participant have been identified, and that an intervention has been designed to reduce these risk factors. More particularly, the relevant economic risk factors have been identified as obesity, high blood pressure, and a diet high in saturated fat, and the intervention includes providing a diet that is low in saturated fat and tracking participation, ensuring that all high blood pressure participants are on medication or losing weight and responding to treatment, and providing instruction for weight management and tracking results. Moreover, assume that an appropriate incentive program has been designed that requires each participant to measure weight once a month and measure blood pressure twice a month. In addition, each participant must view a series of educational videos on heart-healthy nutrition, and keep a dietary record. Finally, assume that each participant is given a weight management plan and must record progress weekly.

In this example scenario, health station 22 facilitates the delivery of the intervention plan and administration of the incentive plan. For example, health station 22 may require each participant 20 to provide authenticating credentials, such as an activity monitor, identification card, fingerprint, or password. Moreover, health station 22 may provide a convenient touch-screen display that allows a participant to activate educational videos related to intervention plan as streaming video, and may provide an interactive weight management plan. Alternatively, healthcare individual 92 can provide a customized intervention plan to participant 20 over a live video feed, which will make intervention plans seem more credible when presented by a qualified healthcare professional 92. Health station 22 may further provide an interface that allows participant to create and manage the dietary record, and record compliance with the weight management plan. For example, participant 20 can download data from activity monitor to health station 22, such that activity data is automatically tracked. Biometric collection devices 72 may measure and record the participant's weight and blood pressure. Additionally, health station 22 may be programmed or otherwise configured to query the participant for information indicative of compliance, such as whether or not participant is taking medications as prescribed. Alternatively, healthcare individual 92 may query participant 20 via a live video feed for information indicative of compliance, such that participant 20 will be more likely to comply since participant 20 will feel accountable in a personal one on one communication session. Finally, the information collected may be transmitted to a remote server 80 or other data processing system via network interface 66, where data may be stored, tracked, and analyzed. Participant 20 may then review a progress report and the status of any rewards or incentives.

It should be noted that the internal structure of the system of FIG. 4 is malleable and can be readily changed, modified, rearranged, or reconfigured in order to achieve its intended operations or additional operations. Accordingly, processor element 64 may be equipped with any suitable component, device, ASIC, hardware, software, processor, algorithm, read only memory (ROM) element, random access memory (RAM) element, erasable programmable ROM (EPROM), electrically erasable programmable ROM (EEPROM), or any other suitable object that is operable to facilitate the operations of processor element 64. Considerable flexibility is provided by the structure of processor element 64.

FIG. 5 is a flow diagram that illustrates one embodiment of an algorithm associated with a health station, which implement various steps described above with reference to FIGS. 1, 2, and 4. This algorithm is described from the perspective of a network-based health station, in which the health station is coupled remotely to a server, data processing system, or second health station through a network. In general, a health station requires each participant to be authenticated. While the algorithm contemplates use of a wide variety of authentication algorithms and systems well-known in the art, one such means includes an identification card having a magnetic stripe or other computer-readable medium. Alternatively, participant can be authenticated by an activity monitor assigned to participant. Each participant may be issued such an identification card or activity monitor, which uniquely identifies the participant to a health station. Thus, in step 500 the remote health station collects the participant's identification, authenticates the identification, and records the identification. In step 502, the health station collects and records health-related data from the participant. Here, the health station may interactively prompt the participant for the information, such as participant's family health history, or may prompt the participant to activate a biometric testing element to measure certain biometric information. Health station may also connect participant to a healthcare individual via a live video feed, and healthcare individual can interactively query participant for additional information.

In step 504, the health station identifies one or more relevant economic risk factors from the health-related data, using any of the techniques, processes, or systems described above with reference to FIGS. 1-4. Healthcare individual can also identify one or more relevant risk factors from health data. In step 506, the health station provides an intervention plan based on the relevant economic risk factors and health data. Again, the health station may be configured to implement any of the techniques, processes, or systems described above to provide the intervention plan dynamically. Alternatively, an administrator may store several static intervention plan options in a centralized server. Health station can intelligently select an intervention plan from server based on the risk factors and health data. Healthcare individual can also provide an intervention plan to participant in a personalized one on one environment via a live video stream. Healthcare individual can provide customized intervention plan based on risk factors and other health data. Step 506 may further comprise steps for delivering elements of the intervention (such as streaming video), tracking participation (e.g., requiring participant authentication before and after viewing a video), storing relevant data, and reporting intervention progress to health station, server, and/or healthcare individual. In step 508, the health station and/or healthcare individual provides an incentive plan to the participant. This step may further comprise tracking and reporting participant's incentive status, and optionally, delivering certain incentives.

FIG. 6 is a simplified flowchart that illustrates an example method for providing an intervention plan for an acute illness in accordance with an embodiment of the present invention. The example process begins at step 602 when employee at company has an acute illness, such as a headache and a runny nose. Employee visits health station, which is located on the company's site. Employee enters participant name and password to log into health station. Allowing employee to visit health station for an acute illness at employee's work site is efficient, immediate, and cost effective for both the employee and the company. At step 604, employee can push a button on health station monitor to call a nurse, such that a live video feed is established. Nurse can see employee in real-time and employee can see nurse in real-time. Additionally, nurse can see any health data that is associated with employee on nurse's computer. At step 606, nurse can ask employee why employee is feeling sick. Employee responds in real time by telling nurse that employee has a headache and a runny nose.

At step 608, nurse can ask employee to measure particular vital signs from health station based on employee's symptoms and employee's health data. At step 610, nurse determines that only the minimal vital signs for diagnosing a common cold should be taken based on employee's symptoms and employee's past health data. Employee can use health station's biometric collection devices to measure employee's temperature, blood pressure, heart rate, and respiratory rate. At step 612, health station transmits employee's biometric data to nurse as biometric data is collected from health station.

At step 614, nurse can analyze employee's current biometric data and employee's past health data stored on centralized server. Employee's biometric data reveals that employee has a high temperature, high blood pressure, a high heart rate, and high respiratory rate. Employee's health data does not reveal any other abnormal health issues. At step 616, nurse can customize the health management for the employee based on employee's health data via the live video transmission. Nurse may determine that employee only has a virus and instruct employee to return home. Nurse can provide additional instructions, such as drink plenty of liquids and get enough sleep. Nurse can tell employee to visit a doctor's office if employee is still feeling sick after 24 hours of complying with nurse's instructions. Alternatively, nurse may determine that employee has a more serious respiratory infection that requires employee to visit a doctor's office for further testing, such as X-rays and/or blood tests. The health station allows for employees to receive immediate, efficient, and cost efficient evaluation, triage and care for acute illnesses.

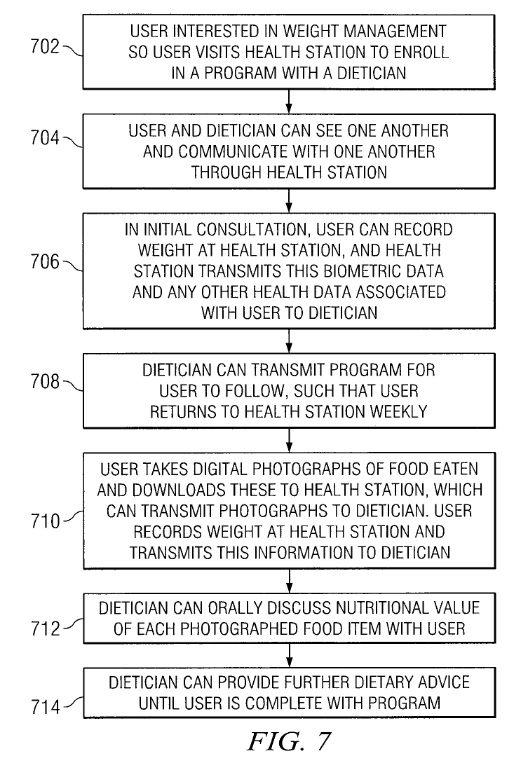

FIG. 7 is a simplified flowchart that illustrates an example method for providing an intervention plan for weight management in accordance with an embodiment of the present invention. The example process begins at step 702 when participant is diabetic and interested in weight management. Participant can visit a conveniently located health station and log into health station. Participant may own activity monitor that can automatically log participant into health station. An option on health station's display allows for participant to enroll in a weight management plan.

At step 704, participant enrolls in weight management plan and health station can create a video session between participant and dietician, such that they can see and hear one another in essentially real time. At step 706, dietician can view any background health data associated with participant that is stored at a centralized server. Dietician can have an initial consultation with participant to receive more data associated with participant before providing a weight management plan customized to participant. Dietician can request participant to measure particular biometric data from health station, such as weight. Participant can use weight scale connected to health station, such that health station records the weight and transmits this data to dietician.

At step 708, dietician can provide an intervention plan that is customized for participant's health data. Dietician can orally instruct participant of the intervention plan and dietician can transmit an electronic intervention plan to participant, such as a nutrition plan and/or activity plan. For example, dietician can instruct participant to view one or more videotapes that provide nutrition and activity information. Dietician can instruct participant how active to be and how many calories participant should consume per day. Dietician can request that participant electronically record participant's activity data, weight, and/or blood sugar level via a health station or access terminal once per day. In addition, dietician can instruct participant to take digital photographs of all food eaten and to record all activity data with activity monitor. Dietician can request biometric data (weight, blood pressure, blood sugar level), activity data, and nutrition data to be inputted electronically by participant via health station or access terminal. Dietician may request to see participant every two weeks via the live video session through health station. This allows dietician to properly monitor participant, such that dietician can see if participant is complying with intervention plans. Additionally, participants are more likely to participate in intervention plans knowing that a dietician is monitoring them, and that they will be held accountable for their actions in a personalized one on one video communication session.

At step 710, participant engages in intervention plans, such as nutrition plan and/or activity plan. Participant uses digital camera to photograph all food that participant eats, and uploads the photographs to centralized server via port on health station or through website on the internet. Participant wears activity monitor and uploads activity data to centralized server via port on health station or through website on the internet. Participant can measure and transfer biometric data (for example, weight and blood pressure) to centralized server directly from health station or participant can manually enter known biometric data through website on the internet. Dietician can view all updated data inputted from participant, such that dietician can survey participant's progress without a scheduled meeting. Furthermore, dietician can send electronic messages to participant or dynamically change participant's intervention plans.

At step 712, participant returns to health station for follow up consultation with dietician via live video stream. Dietician can review all the digital photographs of food that participant has eaten. Dietician can explain nutritional value for each food in an interactive and personalized one on one experience with participant. Dietician can display or tell how many calories participant is eating in comparison to how many calories participant is consuming from activity. Also dietician can query if participant is monitoring blood sugar levels properly since participant is diabetic. At step 714, dietician can continue to provide dietary information and intervention plans to participant until participant completes or withdraws his enrollment in weight management plan.

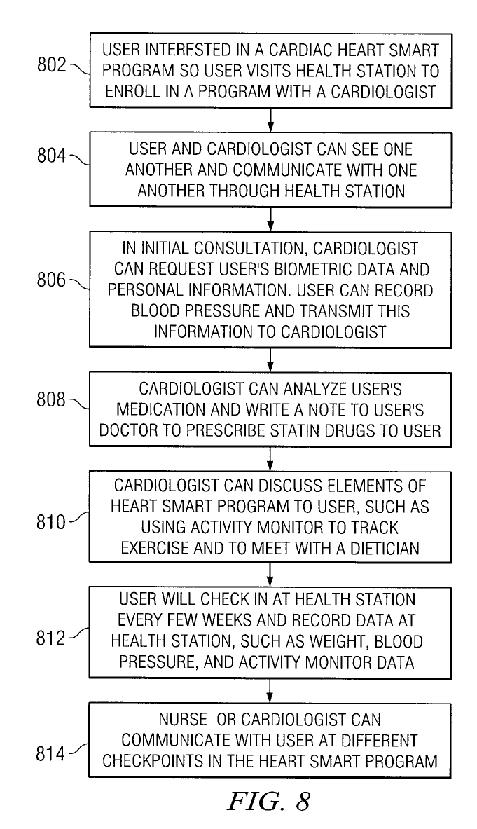

FIG. 8 is a simplified flowchart that illustrates an example method for providing an intervention plan for managing heart disease in accordance with an embodiment of the present invention. The example process begins at step 802 when participant has experienced one or more heart attacks and participant has his own doctor. Ideally, doctors would like for heart attack victims to participate in proper exercise, dieting, and medications. However, doctors do not effectively follow up with patients who have suffered from heart disease. Physicians excel at acute care, but lack the infrastructure, tracking, monitoring and rewards systems for long term risk modification. As a result, data reveals that after patients have been prescribed with a statin medicine to lower LDL levels, within 2 years only 50% of patients are still taking their drugs even though it is a known fact that compliance with the medication significantly reduces future cardiac events. Doctors lack the infrastructure to track, monitor, and influence their patients for risk modification. Personal doctor for participant or participant himself can enroll participant in a heart disease intervention plan. Participant can visit a conveniently located health station and log into health station. Participant may own activity monitor that can automatically log participant into health station. An option on health station's display allows for participant to enroll in a “Heart Smart” plan that allows for participant to interact with a cardiologist who can provide an intervention plan to participants with heart disease.

At step 804, participant enrolls in Heart Smart plan, and health station can stream a video introduction of the program to participant. After completing the introduction, health station can establish a live video session between participant and cardiologist, such that they can see and hear one another in essentially real time. Cardiologist can explain to participant that he is not participant's personal doctor, but that he is just here to provide and monitor a Heart Smart plan for participant. Cardiologist can express the importance of complying with the Heart Smart plan to participant, such that participant will be more likely to heed the advice of a qualified healthcare professional in a one on one personalized setting. At step 806, cardiologist can view any background health data associated with participant that is stored at a centralized server, such as details related to heart attacks, past and present medication prescriptions, by pass surgery, angioplasties, age, weight, gender, etcetera. Cardiologist can have an initial consultation with participant to receive more data associated with participant before providing a Heart Smart plan customized to participant. Cardiologist or nurse can request participant to measure particular biometric data from health station, such as weight and blood pressure. Participant can use weight scale connected to health station, such that health station records the weight and transmits this data to cardiologist. Similarly, participant can use blood pressure arm cuff connected to health station, such that health station records the blood pressure and transmits this data to cardiologist.

At step 808, cardiologist can provide an intervention plan that is customized to participant's health data. Cardiologist can review medication prescribed to participant. For example, cardiologist can notify participant's personal doctor suggesting that statin drugs be prescribed to participant. Additionally, cardiologist can write a note to participant's personal doctor suggesting that different medication for reducing blood pressure should be prescribed since the previous prescription does not seem to be very effective.

At step 810, cardiologist can orally instruct participant of the intervention plan and/or cardiologist can transmit an electronic intervention plan to participant, such as a nutrition plan and/or activity plan. For example, cardiologist may establish a twelve week plan for participant to complete. Cardiologist can instruct participant to be compliant with medication, meet with a dietician, and use an activity monitor. Details related to meeting with a dietician via health station are explained above in FIG. 7. Cardiologist can request that participant electronically record participant's activity data, weight, blood lipids, and/or blood pressure level via a health station or access terminal once per day. Cardiologist may request that participant meet with a nurse after six weeks via a live video session through health station. At the completion of the twelve week plan, cardiologist can meet with participant via a live video session through health station. This allows cardiologist and/or nurse to properly monitor participant, such that they can see if participant is complying with intervention plans. Additionally, participants are more likely to participate in intervention plans knowing that a qualified health professional is monitoring them, and that they will be held accountable for their actions in a personalized one on one video communication session.

At step 812, participant engages in intervention plans, such as medication plan, nutrition plan, and/or activity plan. Participant can electronically confirm that participant has visited doctor for a new prescription, and that participant is complying with taking the medication. Participant can comply with activity plan by wearing activity monitor and uploading activity data to centralized server via port on health station or through website on the internet. Participant can measure and transfer biometric data (for example, weight and blood pressure) to centralized server directly from health station or participant can manually enter known biometric data through website on the internet. Additionally, participant complies with intervention plan provided by dietician. Details related to complying with a dietician's intervention plan are explained above in FIG. 7. Cardiologist and/or nurse can view all updated data inputted from participant, such that cardiologist and/or nurse can survey participant's progress without a scheduled meeting.

At step 814, cardiologist and/or nurse can send electronic messages to participant or dynamically change participant's intervention plans. Participant returns to health station for follow up consultation with cardiologist and/or nurse via live video stream. Cardiologist and/or nurse can review all submitted data from participant in an interactive and personalized one on one experience with participant. Also cardiologist and/or nurse can query if participant is monitoring blood lipid levels properly since participant has suffered from a heart attack. Cardiologist can continue to provide health information and intervention plans to participant until participant successfully completes the Heart Smart plan.

It is important to note that the stages and steps described above illustrate only some of the possible scenarios that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within health station to effectuate the tasks and operations of the elements and activities associated with executing compatibility functions.

Certain features of the invention have been described in detail with reference to particular embodiments in FIGS. 1-8, but it should be understood that various other changes, substitutions, and alterations may be made hereto without departing from the sphere and scope of the present invention. For example, although the preceding FIGURES have referenced a number of relevant health risk factors, any suitable characteristics or relevant parameters may be readily substituted for such elements and, similarly, benefit from the teachings of the present invention. These may be identified on a case by case basis, whereby a certain participant may present a health risk factor while another (with the same condition) may not. Thus, a statistical relevance may be identified for one group, but not another who appears to be similar. Additionally, different and unique intervention plans can be customized by healthcare individuals and/or servers.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for modifying risk factors by a healthcare individual at a remote location, the method comprising:
interacting with a participant at a remote location to obtain health-related data, wherein the interaction occurs during a video session;
determining an intervention plan to the participant based on the health-related data; and
communicating data associated with the intervention plan to the participant during the video session.

2. The method of claim 1, further comprising providing health management to the participant.

3. The method of claim 1, further comprising:
determining a surveillance plan for the participant based on the health-related data; and
following up with the participant based on the surveillance plan.

4. The method of claim 1, further comprising:
identifying one or more relevant risk factors from health-related data collected from the participant; and
analyzing the risk factors to determine the intervention plan for the participant.

5. The method of claim 1, wherein the video session is live.

6. The method of claim 1, further comprising:
providing a health station at a remote location;
capturing biometric data from the participant at the health station;
storing the biometric data;
transmitting the biometric data; and
analyzing the biometric data to determine the intervention plan for the participant.

7. The method of claim 6, wherein the health station is located where participant works.

8. The method of claim 6, wherein the biometric data is a selected one of a group of biometric data, the group consisting of:
a) blood pressure;
b) pulse;
c) glucose levels;
d) weight; and
e) air flow.

9. The method of claim 1, wherein the intervention plan is determined by a healthcare individual, wherein the healthcare individual is a selected one of group of healthcare individuals, the group consisting of:
a) a physician;
b) a cardiologist;
c) a nurse;
d) a dietician;
e) a non-licensed individual; and
f) a licensed individual.

10. The method of claim 1, wherein the health-related data is a selected one of a group of health-related data, the group consisting of:
a) activity data;
b) medication data;
c) risk factors;
d) health risk appraisal data;
e) biometric data;
f) utilization data;
g) risk level;
h) age;
i) gender; and
j) weight.

11. The method of claim 1, wherein the intervention plan is a selected one of a group of intervention plans, the group consisting of:
a) acute illness;
b) chronic illness;
c) nutrition;
d) weight management;
e) cardiac disease;
f) unplanned pregnancies; and
g) stress management.

12. The method of claim 1, wherein the intervention plan comprises one or more intelligently selected health education videos based on health-related data associated with the participant.

13. The method of claim 1, further comprising scheduling a time to begin the video session.

14. A system for modifying risk factors by a healthcare individual at a remote location, comprising:
a health station utilized by a participant, the health station operable to provide the participant with a video session with a healthcare individual;
an access terminal;
the healthcare individual operating the access terminal, the healthcare individual operable to:
interact with the participant at a remote health station to obtain health-related data, wherein the interaction occurs during the video session;
determine an intervention plan for the participant based on the health-related data; and
communicate data associated with the intervention plan to the participant at the remote health station during the video session.

15. The system of claim 14, wherein the healthcare individual is further operable to provide health management to the participant.

16. The system of claim 14, wherein the healthcare individual is further operable to:
determine a surveillance plan for the participant based on the health-related data and the additional data; and
follow up with the participant based on the surveillance plan.

17. The system of claim 14, wherein the healthcare individual is further operable to:
identify one or more relevant risk factors from health-related data collected from the participant; and
analyze the risk factors to determine the intervention plan for the participant.

18. The system of claim 14, wherein the video session is live.

19. The system of claim 14, wherein the system further comprises:
the health station is further operable to:
capture biometric data from the participant at the health station;
store the biometric data; and
transmit the biometric data.
the healthcare individual is further operable to:
analyze the biometric data to determine the intervention plan for the participant.

20. The system of claim 19, wherein the biometric data is a selected one of a group of biometric data, the group consisting of:
a) blood pressure;
b) pulse;
c) glucose levels;
d) weight; and
e) air flow.

21. The system of claim 14, wherein the health station is located where participant works.

22. The system of claim 14, wherein the healthcare individual is a selected one of group of healthcare individuals, the group consisting of:
a) a physician;
b) a cardiologist;
c) a nurse;
d) a dietician;
e) a non-licensed individual; and
f) a licensed individual.

23. The system of claim 14, wherein the health-related data is a selected one of a group of health-related data, the group consisting of:
a) activity data;
b) medication data;
c) risk factors;
d) health risk appraisal data;
e) biometric data;
f) utilization data;
g) risk level;
h) age;
i) gender; and
j) weight.

24. The system of claim 14, wherein the intervention plan is a selected one of a group of intervention plans, the group consisting of:
a) acute illness;
b) chronic illness;
c) nutrition;
d) weight management;
e) cardiac disease;
f) unplanned pregnancies; and
g) stress management.

25. The system of claim 14, wherein the intervention plan comprises one or more intelligently selected health education videos based on health-related data associated with the participant.

26. The system of claim 14, wherein the health station is further operable to schedule a time to begin the video session.

27. An apparatus for modifying risk factors by a healthcare individual at a remote location, comprising:
a network interface operable to communicate with a communication network;
a video camera operable to provide a video session of participant to a healthcare individual at a remote location, wherein the healthcare individual is operable receive health-related data associated with the participant and determine an intervention plan for the participant based on the health-related data;
a communication device operable to communicate data associated with the intervention plan to the participant during the video session; and
a display operable to display the video session.

28. The apparatus of claim 27, wherein the healthcare individual is further operable to provide health management to the participant.

29. The apparatus of claim 27, wherein the video session is live.

30. The apparatus of claim 27, wherein the video camera is further operable to interact with the healthcare individual to identify one or more relevant risk factors from health-related data collected from the participant, the healthcare individual operable to analyze the risk factors to determine the intervention plan for the participant.

31. The apparatus of claim 27, further comprising:
one or more biometric collection devices operable to capture biometric data from the participant;
the memory further operable to store the biometric data;
the network interface further operable to transmit the biometric data to the healthcare individual, the healthcare individual operable to analyze the biometric data to determine the intervention plan for the participant.

32. The apparatus of claim 27, wherein the biometric data is a selected one of a group of biometric data, the group consisting of:
a) blood pressure;
b) pulse;
c) glucose levels;
d) weight; and
e) air flow.

33. The apparatus of claim 27, wherein the apparatus is located where participant works.

34. The apparatus of claim 27, wherein the healthcare individual is a selected one of group of healthcare individuals, the group consisting of:
a) a physician;
b) a cardiologist;
c) a nurse;
d) a dietician;
e) a non-licensed individual; and
f) a licensed individual.

35. The apparatus of claim 27, wherein the health-related data is a selected one of a group of health-related data, the group consisting of:
a) activity data;
b) medication data;
c) risk factors;
d) health risk appraisal data;
e) biometric data;
f) utilization data;
g) risk level;
h) age;
i) gender; and
j) weight.

36. The apparatus of claim 27, wherein the intervention plan is a selected one of a group of intervention plans, the group consisting of:
a) acute illness;
b) chronic illness;
c) nutrition;
d) weight management;
e) cardiac disease;
f) unplanned pregnancies; and
g) stress management.

37. The apparatus of claim 27, wherein the intervention plan comprises one or more intelligently selected health education videos based on health-related data associated with the participant.

38. The apparatus of claim 27, further comprising a processor for scheduling a time to begin the video session.

39. A system for modifying risk factors by a healthcare individual at a remote location, comprising:
means for interacting with a participant at a remote location to obtain health-related data, wherein the interaction occurs during a video session;
means for determining an intervention plan for the participant based on the health-related data; and
means for communicating data associated with the intervention plan to the participant during the video session.
